(19) United States
(12) Patent Application Publication
(10) Pub. No.: US 2006/0226962 A1
(43) Pub. Date: Oct. 12, 2006

(54) Vehicle engine-room lighting device

(76) Inventor: Tsan-Lin Cheng, Yung-Kang City (TW)

Correspondence Address: Tsan-Lin CHENG, P.O. BOX 90, Tainan City, 70499, TW

(21) Appl. No.: 11/102,788

(22) Filed: Apr. 11, 2005

(51) Int. Cl. B60R 25/10

(52) U.S. Cl. 340/426.29

(57) ABSTRACT

A vehicle engine-room lighting device includes a light having at least an LED, two wires and a touch switch positioned on a vehicle body and facing to an edge of a hood of a vehicle. One of the wires has two ends respectively connected with the light and a terminal connected with a positive of a battery, and the other wire has two ends respectively connected with the light and the touch switch which consists of a coil spring in a shell and a press rod on the coil spring and has its lower end connected with a negative of the battery. Then the press rod is pushed up by the coil spring so far pressed down by the hood closed on the engine room when the hood is opened up so that a circuit of the device is closed to light up the light for shining and warning.

### BACKGROUND OF THE INVENTION

1. Field of the Invention

This invention relates to a vehicle engine-room lighting device, particularly to one provided with at least an LED connected with two wires, and one of the two wires with its end connected with a terminal connected with a positive of the battery in a vehicle, and the other wire is connected with a touch switch positioned on a vehicle body to face to the edge of the hood of a vehicle. The touch switch has a coil spring in a shell, a press rod positioned on the coil spring and a lower end connected with the negative of the battery with a wire.

When the hood is opened up, the press rod in the shell of the touch switch is elastically pushed up by the coil spring to let the circuit of the lighting device closed to light up the LED for lighting the engine room.

2. Description of the Prior Art

The engine room of a vehicle are generally not provided with a lighting device, so if there is a disorder and the components in the engine room have to be checked, a worker opens the hood, and has to use a light or a flashlight for lightening the engine room. So it is very inconvenient to handle, and this invention has been devised.

### SUMMARY OF THE INVENTION

The feature of the invention is a light having at least a LED connected with two wires, and one wire has its end connected with a terminal connected with the positive of the battery in a vehicle, and the other wire is connected with a touch switch, which is then connected with a negative of the battery. The touch switch is positioned to face to an edge of the hood of the vehicle, consisting of a coil spring deposited in a shell, and a press rod on the coil spring in the shell, connected at its lower end with the negative of the battery. When the hood is closed on the engine room, the touch switch is electrically cut off the power of the battery, with the LED light not lit up. When the hood is opened up, the touch switch is turned on to light up the LED light.

### BRIEF DESCRIPTION OF DRAWINGS

This invention will be better understood by referring to the accompanying drawings, wherein:

FIG. 1 is a perspective view of a vehicle engine-room lighting device in the present invention;

FIG. 2 is a perspective view of he vehicle engine-room lighting device in the present invention, showing it installed in a vehicle;

FIG. 3 is a side view of the vehicle engine-room lighting device in the present invention, showing the hood of a vehicle opened up;

FIG. 4 is a magnified view of the part marked E in FIG. 3;

FIG. 5 is a side view of the vehicle engine-room lighting device in the present invention, showing the hood of a vehicle closed down; and,

FIG. 6 is a magnified view of the part market F in FIG. 5.

### DETAILED DESCRIPTION OF THE PREFERRED EMBODIMENT

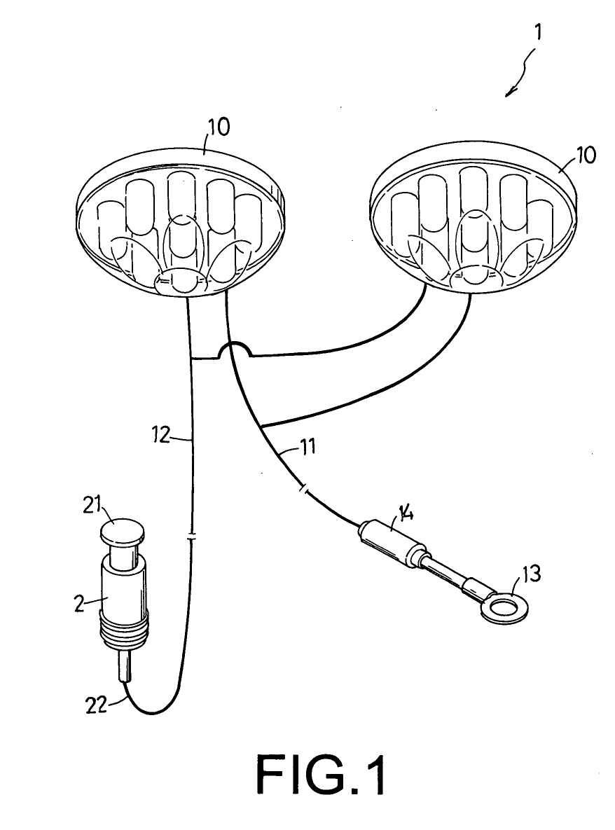

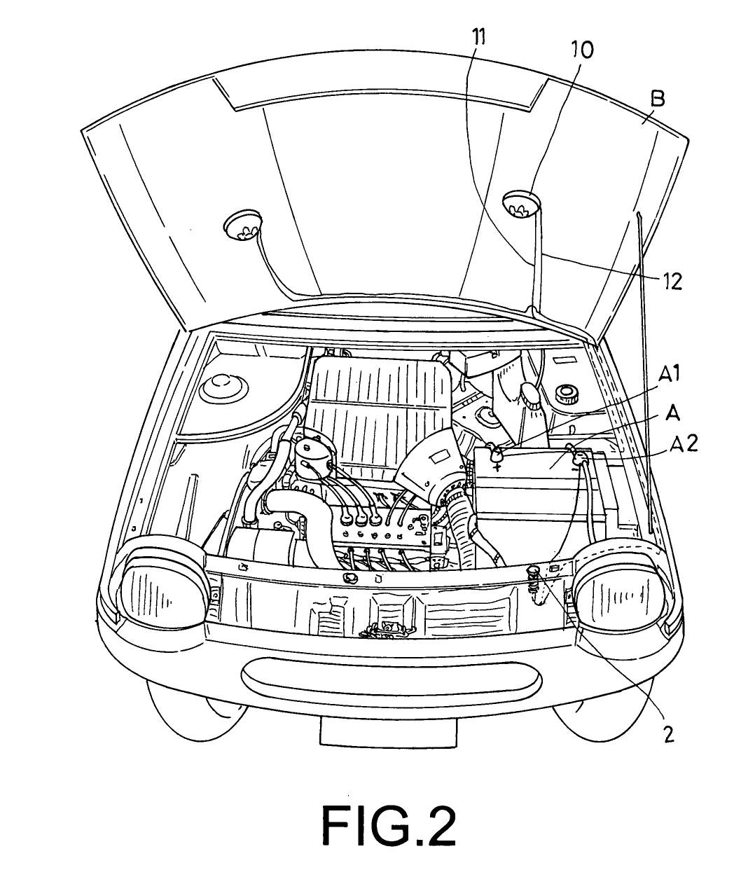

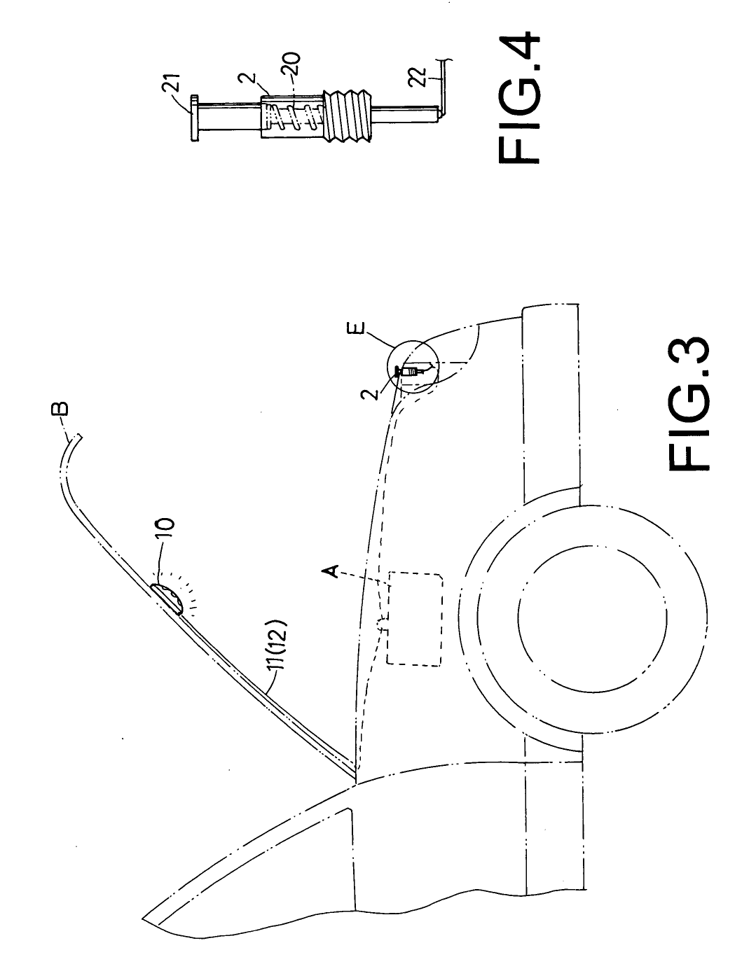

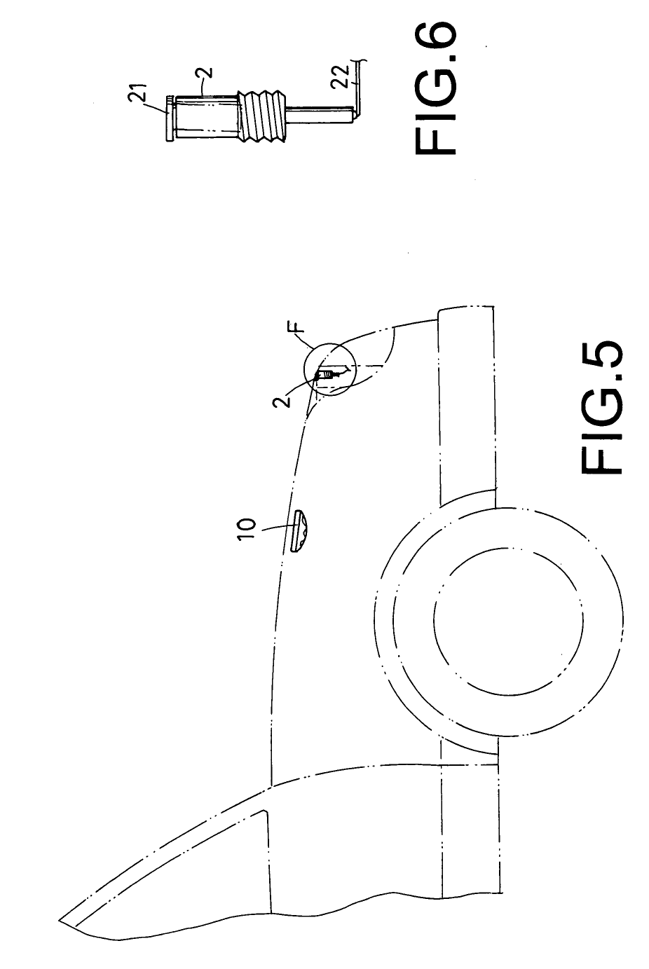

A preferred embodiment of a vehicle engine-room lighting device in the present invention, as shown in FIGS. 1 to 6, includes a light 10 consisting of at least a LED, two wires 11, 12 connected with the light 10, and a touch switch 2, as main components.

The light 10 is fixed on a lower surface of the hood (B) of a vehicle.

The first wire 11 has its one end connected with the light 10 and the other end connected with a terminal 13 and a fuse 14 in series, and the terminal 13 is further connected with the positive (A1) of the battery of a vehicle. The second wire 12 has one end connected with the light 10 and the other end connected with a touch switch 2, which is positioned on the vehicle, facing to the edge of the hood (B) of the vehicle.

The touch switch 2 consists of a coil spring 20 in a cylindrical shell and a press rod 21 on the coil spring 20 in the shell, having its lower end connected electrically with the negative (A2) of the battery.

In using the vehicle engine room lighting device, when the hood (B) is opened up, the press rod 21 is pushed up by the recovered elasticity of the coil spring 20 so far pressed by the hood (B) closed down, Then the touch switch 2 turns on the electricity of the battery, lighting up the light 10. When the hood (B) is pushed down and closed on the engine room, the edge of the hood (B) may press down the touch switch 2 to cut off the electricity of the battery, with the light 10 also cut off the power.

Next, the light 10 can have more than one LED, and also be made to flash on-and-off so as to reinforce its brilliance for shining clearly on the engine room or warning.

This invention has the following advantages, as can be seen from the above description.

1. It is useful for shining the engine room of a vehicle, especially during nighttime for convenience of checking and repairing.

2. The light can be formed with more than one LED, and also can be made to flash on-and-off for reinforcing its brilliance and drawing attention easily.

3. The LED uses lower power of electricity, able to be lit up even if the power of the battery of a vehicle is so low as not to start the engine.

While the preferred embodiment of the invention has been described above, it will be recognized and understood that various modifications may be made therein and the appended claims are intended to cover all such modifications that may fall within the spirit and scope of the invention.

What is claimed is:

1. A vehicle engine-room lighting device comprising a light having at least a LED, two wires and a touch switch, one of said two wires having one end connected with said light and the other end connected with a terminal connected with a positive of a battery in a vehicle, the other wire having one end connected with said light and the other end connected with said touch switch, said touch switch fixed on a vehicle body and facing to an edge of a hood of said vehicle, said touch switch having a coil spring in a shell and a press rod placed on said coil spring in said shell, said touch switch having its lower end connected with a negative of said battery in said vehicle;
said press rod of said touch switch pushed up by said coil spring so far pressed down by said hood closed on said engine-room of said vehicle when said hood is opened so that a circuit of said lighting device is closed and lights up said light; said hood pressing down said press rod of said touch switch when said hood is shut down on said engine-room so that said circuit of said lighting device is cut off, with said light cut off, too.

2. The vehicle engine-room lighting device as claimed in claim 1, wherein said light has more than one LED, and also able to flash on-and-off so as to reinforce its brilliance to attract attention easily.
